(19) United States
(12) Patent Application Publication
(10) Pub. No.: US 2026/0337340 A1
(43) Pub. Date: Oct. 29, 2026

(54) Resin

(71) Applicant: A.C.R. TECH CO., LTD., Taipei (TW)

(72) Inventors: Sheng-De LI, Taipei (TW); Bei-Yu LIN, Taipei (TW); Wei-Hsuan CHEN, Taipei (TW)

(21) Appl. No.: 19/178,221

(22) Filed: Apr. 14, 2025

(51) Int. Cl. C08G 65/38

(52) U.S. Cl. CPC C08G 65/38

(57) ABSTRACT

A phosphorus-containing polyphenylene ether resin comprising 2,6-dimethylphenylene ether and one or more phosphorus-containing functional groups of 9,10-dihydro-9-oxa-10-phosphaphenanthrene-10-oxide attached to the 2,6-dimethylphenylene ether, wherein the phosphorus-containing functional group is linked to the 2,6-dimethylphenylene ether via an alkenyl.

### FIELD OF THE INVENTION

The present invention relates to a resin, particularly a phosphorus-containing polyphenylene ether resin.

### BACKGROUND OF THE INVENTION

Polyphenylene ether (PPO/PPE) is a thermoplastic polymer material recognized for its excellent mechanical properties and dielectric characteristics, making it a preferred material for high-frequency printed circuit boards. In the technical field, numerous studies have addressed the processing challenges of polyphenylene ether due to its high melt viscosity, poor solvent resistance, and insufficient heat resistance. Various modification methods have been developed to effectively enhance its processability, thereby further unlocking the application potential of polyphenylene ether.

However, even with these modifications, the flame retardancy of polyphenylene ether remains inadequate, typically necessitating the addition of flame retardants to meet practical application requirements. Commonly used flame retardants include halogen-based and phosphorus-based flame retardants. Halogen-based flame retardants release toxic gases during combustion, posing risks to the environment and human health. While phosphorus-based flame retardants are more environmentally friendly, their practical application requires complex chemical modification processes, such as the synthesis of phosphorus-containing bisphenols, which complicates the overall manufacturing process and increases costs. Additionally, the synthesis of phosphorus-based flame retardants often involves difunctional reactive monomers, requiring separation and purification of byproducts, further elevating manufacturing complexity and uncertainty.

US Patent No. U.S. Pat. No. 11,787,904 discloses a phosphorus-containing (2,6-dimethylphenylene ether) oligomer. The oligomer integrates 9,10-dihydro-9-oxa-10-phosphaphenanthrene-10-oxide (DOPO) to introduce a phosphorus-containing structure into the (2,6-dimethylphenylene ether) oligomer. While this improves thermal properties, the synthesis process requires the initial introduction of an aldehyde group, followed by attachment of DOPO to the aldehyde group. This multi-step synthesis, particularly for commercial-scale production, increases both cost and processing time.

### SUMMARY OF THE INVENTION

A resin has a structure represented by the following Formula A:

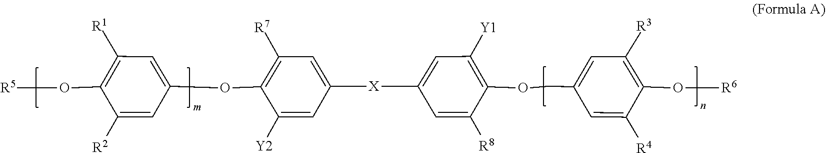

wherein each of the substituents R¹ to R⁴ are the same or different, and are independently selected from hydrogen, a substituted or unsubstituted aromatic ring, a substituted or unsubstituted C1 to C5 alkyl, and a substituted or unsubstituted C2 to C5 alkenyl;
m and n are each independently an integer ranging from 0 to 100, with the proviso that m and n are not simultaneously 0;
wherein each of the substituents R⁵ and R⁶ are the same or different, and are independently selected from hydrogen, a group comprising an alkenyl moiety,

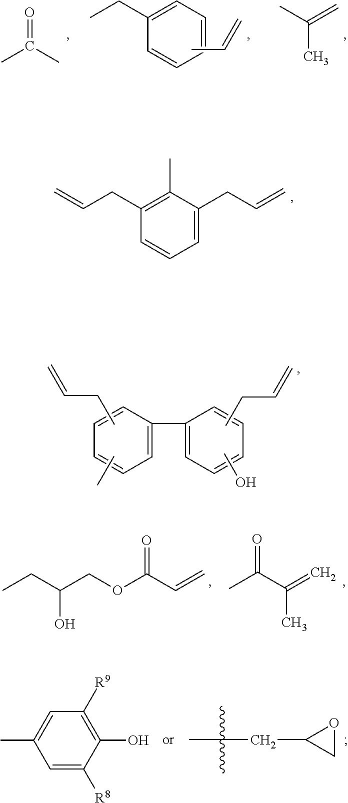

wherein X is a single bond, —CH₂—,

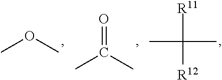

### —SO₂

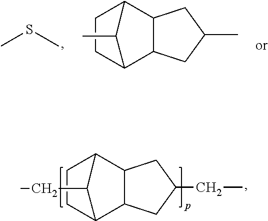

wherein p is a positive integer;
wherein each of the substituents R⁷ to R¹² are the same or different, and are independently selected from hydrogen, a C1 to C12 alkyl, or CF₃;
wherein each of the substituents Y1 and Y2 are the same or different, and are independently selected from a functional group comprising 9,10-dihydro-9-oxa-10-phosphaphenanthrene-10-oxide (DOPO).

A resin has a structure represented by the following Formula B:

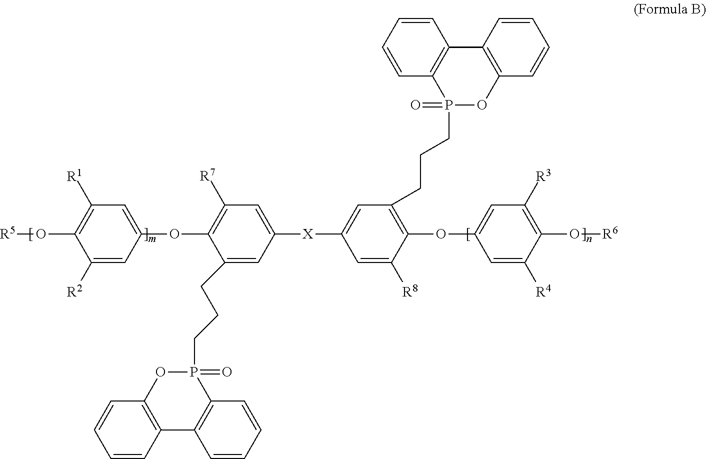

wherein each of the substituents R¹ to R⁴ are the same or different, and are independently selected from hydrogen, a substituted or unsubstituted aromatic ring, a substituted or unsubstituted C1 to C5 alkyl, and a substituted or unsubstituted C2 to C5 alkenyl;
m and n are each independently an integer ranging from 0 to 100, with the proviso that m and n are not simultaneously 0;
wherein each of the substituents R⁵ and R⁶ are the same or different, and are independently selected from hydrogen, a group comprising an alkenyl moiety,

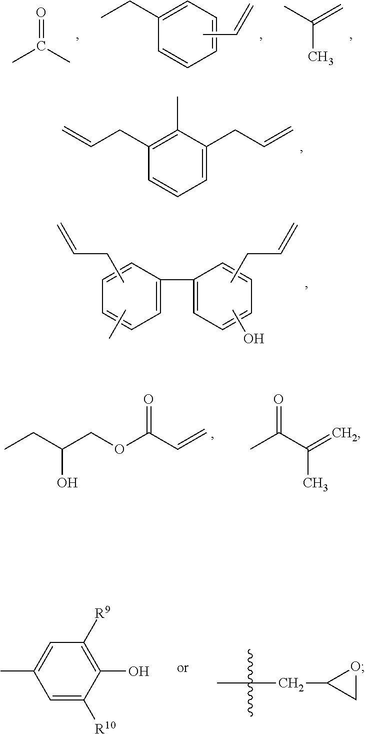

wherein X is a single bond, —CH₂—,

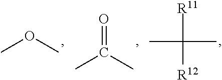

### —SO₂

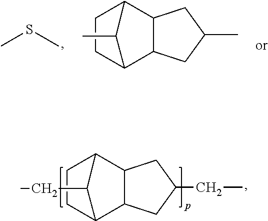

wherein p is a positive integer;
wherein each of the substituents R⁷ to R¹² are the same or different, and are independently selected from hydrogen, a C1 to C12 alkyl, or CF₃.

A low molecular weight phosphorus-containing polyphenylene ether resin comprises 2,6-dimethylphenylene ether and one or more phosphorus-containing functional groups comprising 9,10-dihydro-9-oxa-10-phosphaphenanthrene-10-oxide (DOPO) attached to the 2,6-dimethylphenylene ether, wherein the phosphorus-containing functional groups are grafted onto the main chain structure of the 2,6-dimethylphenylene ether via an alkenyl during synthesis, and wherein the polyphenylene ether resin has a number average molecular weight (Mn) and a weight average molecular weight (Mw) satisfying at least one of the following:
Mn ranges from 1,000 to 15,000;
Mw ranges from 1,000 to 25,000; and
the ratio Mw/Mn ranges from 1 to 25.

### DETAILED DESCRIPTION

One aspect of the present invention provides a resin, particularly a phosphorus-containing low molecular weight polyphenylene ether (PPO/PPE) resin, such as a capped polyphenylene ether resin. In one example, the resin is a phosphorus-containing oligo (2,6-dimethylphenylene ether) and has the structure represented by following Formula A:

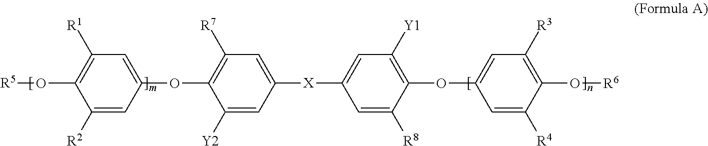

wherein each occurrence of R¹, R², R³, and R⁴ are the same or different, and are independently comprises hydrogen, a substituted or unsubstituted aromatic ring, a substituted or unsubstituted C1 to C5 alkyl, or a substituted or unsubstituted C2 to C5 alkenyl. m and n are each independently a value ranging from 0 to 100, wherein m and n are not simultaneously 0, and m and n may independently be an integer or a non-integer.
wherein each occurrence of R⁵ and R⁶ are the same or different, and are independently comprises hydrogen, a group containing an alkenyl moiety,

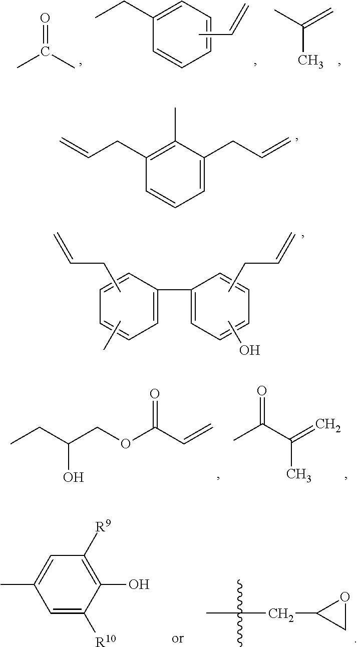

X may be a single bond, —CH₂—,

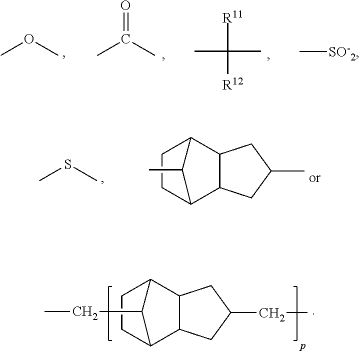

wherein each occurrence of R⁷, R⁸, R⁹, R¹⁰, R¹¹, and R¹² are the same or different, and are independently comprises hydrogen, a C1 to C12 alkyl, or CF₃, and p is a positive integer. For example, p is 1 or 2.

In one embodiment, the number average molecular weight (Mn) and weight average molecular weight (Mw) of the compound of Formula A satisfy at least one of the following: Mn ranges from 1,000 to 15,000; Mw ranges from 1,000 to 25,000; and the ratio Mw/Mn ranges from 1 to 25.

Y1 and Y2 in Formula A are each independently a functional group comprising 9,10-dihydro-9-oxa-10-phosphaphenanthrene-10-oxide (DOPO), Y1 and Y2 may be identical or different functional groups. In one example, Formula A may have the structure of the following Formula B, which comprises possible structures for Y1 and Y2.

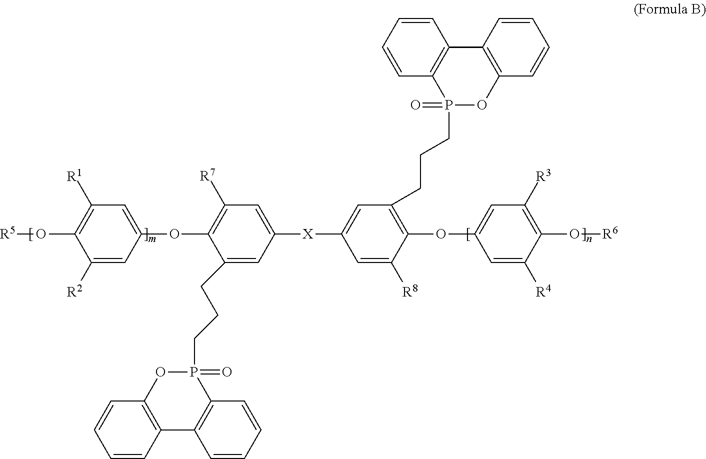

In one embodiment, the alkenyl-containing groups in R⁵ and R⁶ are the same or different, and are a C2 to C5 alkenyl.

In one embodiment, the alkenyl-containing groups in R⁵ and R⁶ are the same or different, and are acryloyl group, allyl group, vinylbenzyl group, or methacryloyl group.

In one embodiment, the alkenyl-containing group in R⁵ and R⁶ are allyl chloride.

In one embodiment, the number average molecular weight (Mn) and weight average molecular weight (Mw) of the compound of Formula B satisfy at least one of the following: Mn ranges from 1,000 to 15,000; Mw ranges from 1,000 to 25,000; and the ratio Mw/Mn ranges from 1 to 25.

Each of the Formula A and Formula B may be characterized as a C-B-A-B′-C′ type, where A is a central core unit, B and B′ are repeating units symmetrically attached to the central core unit on both sides, and C and C″ are termini modified with specific capping groups, symmetrically attached to the repeating units, forming a linear structure.

The central core unit A may be a phenylene ether comprising two phenyl rings connected by a linking group X. The phenyl rings on both sides may be the same or different. Each phenyl ring is substituted with at least one phosphorus-containing functional groups (containing DOPO). The central core unit A is as follows:

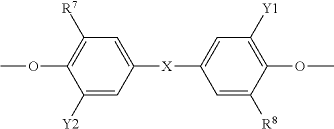

The repeating unit groups B, B′ are as follows, respectively:

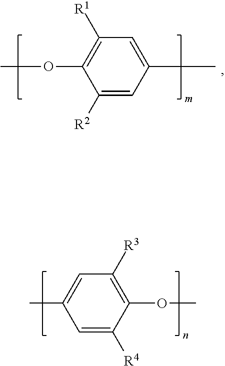

The capping groups C, C′ are R⁵ and R⁶, respectively.

In one example, the linking group X of the central core unit A in the Formula A and Formula B contains neither DOPO nor phosphorus-containing group. In one example, the repeating unit groups B, B′ and the capping groups C, C′ in the Formula A and Formula B contains neither DOPO nor phosphorus-containing group.

In another example, the phosphorus-containing functional groups (containing DOPO) in Formula A and Formula B are attached to the phenyl ring of the central core unit via the double bond of an alkenyl. In certain examples, the synthesis process of Formula A and Formula B does not involve introducing an aldehyde group to attach the phosphorus-containing functional groups (containing DOPO).

One aspect of the present invention provides a low molecular weight phosphorus-containing polyphenylene ether resin comprising 2,6-dimethylphenylene ether and one or more phosphorus-containing functional groups comprising 9,10-dihydro-9-oxa-10-phosphaphenanthrene-10-oxide (DOPO) attached thereto, wherein the phosphorus-containing functional groups are grafted onto the 2,6-dimethylphenylene ether via an alkenyl, and wherein the polyphenylene ether resin's number average molecular weight (Mn) and weight average molecular weight (Mw) satisfy at least one of the following: Mn ranges from 1,000 to 15,000; Mw ranges from 1,000 to 25,000; and the ratio Mw/Mn ranges from 1 to 25.

Another aspect of the present invention provides a method for preparing a low molecular weight phosphorus-containing polyphenylene ether resin, comprising first preparing a 2,6-dimethylphenylene ether, wherein the main chain (or phenylene ether) of the 2,6-dimethylphenylene ether has one or more alkenyls, followed by grafting phosphorus-containing functional groups onto the alkenyls of the main chain (or phenylene ether).

Since the polyphenylene ether resin of the present invention is grafted onto the main chain structure of 2,6-dimethylphenylene ether via an alkenyl, the synthesis process is simplified, reducing processing time and cost while enhancing stability for mass production.

To further illustrate the features of the phosphorus-containing polyphenylene ether resin disclosed herein, the following examples based on the present invention and comparative examples using other techniques are provided.

### Example of Phosphorus-Containing PPO

The phosphorus-containing PPO prepared in this example is referred to as PPO-1A. First, 150 mL of toluene was added to a 1-liter four-neck reaction kettle, followed by 0.25 g of copper chloride and 5.3 g of pyridine to prepare a metal composite catalyst.

Subsequently, 36.6 g of 2,6-dimethylphenol and 15.4 g of ortho-diallyl bisphenol A (ortho-diallyl BPA) were formulated into a 50 wt. % methanol solution of 2,6-dimethylphenol and ortho-diallyl bisphenol A (ortho-allyl BPA).

Oxygen was introduced, and the methanol solution was added dropwise to the reaction kettle over 20 minutes. Next, the temperature was controlled between 30° C. and 35° C., and the reaction was carried out for 120 minutes. Upon completion, 1.05 g of 36.5 wt. % hydrochloric acid was added, stirred for 30 minutes, and 500 mL of methanol was added to precipitate the product.

The precipitate was washed with methanol, and the filter cake was vacuum-dried at 110° C. for 4 hours, yielding a PPO with a structure as shown in Formula 1a and a number average molecular weight (Mn) of approximately 1,000.

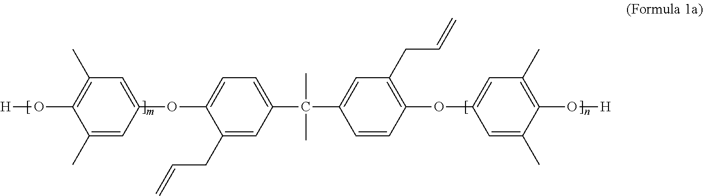 [SMILES: C=CCc1cc(C(C)(C)c2ccc(Oc3cc(C)c(O)c(C)c3)c(CC=C)c2)ccc1Oc1cc(C)c(O)c(C)c1]

The value of m+n of PPO-1a approximates 4.

Further, 30.0 g of 9,10-dihydro-9-oxa-10-phosphaphenanthrene-10-oxide (DOPO) was added to the reaction kettle, and the temperature was controlled at 140° C. until DOPO was fully melted. Then, 10.0 g of the PPO powder of Formula 1a was added with continuous stirring, and the temperature was raised to 170° C. for 20 hours. Upon completion, 100 mL of ethanol was added, the temperature was controlled at 78° C. until the reactants were fully dissolved, followed by the addition of 400 mL of water, with the temperature controlled at 85° C., and stirring and washing for 1 hour. The washing process was repeated four times, followed by solvent removal and drying, yielding a phosphorus-containing PPO with a structure as shown in Formula 1A and a number average molecular weight (Mn) of approximately 1,463, designated as PPO-1A.

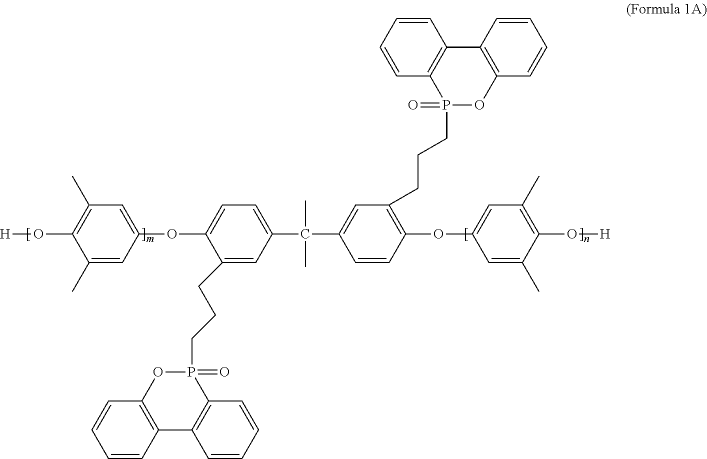 [SMILES: Cc1cc(Oc2ccc(C(C)(C)c3ccc(Oc4cc(C)c(O)c(C)c4)c(CCCP4(=O)Oc5ccccc5-c5ccccc54)c3)cc2CCCP2(=O)Oc3ccccc3-c3ccccc32)cc(C)c1O]

The present invention also discloses a benzoxazine (BZ) resin suitable for mixing with the aforementioned phosphorus-containing polyphenylene ether resin. In one embodiment, the formula of the benzoxazine resin is as shown in Formula 2. In another embodiment, the formula of the benzoxazine resin is as shown in Formula 3.

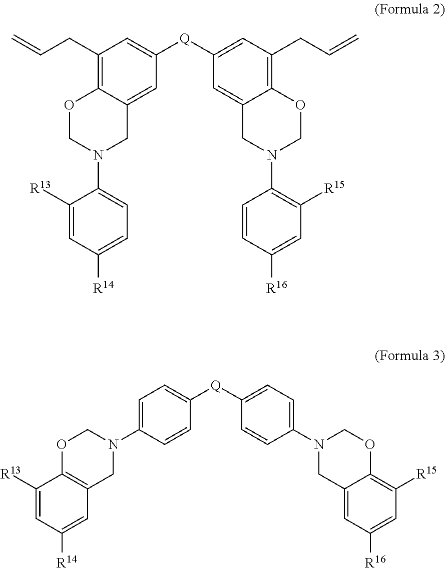

An exemplary preparation of the benzoxazine resin is further described below. First, 924 g of ortho-diallyl bisphenol A (ortho-diallyl BPA), 558 g of aniline, and 600 g of toluene were added to a 3-liter four-neck separable reaction flask equipped with a heating device, thermometer, stirrer, cooling tube, dropping device, and vacuum recovery device, forming a synthesis solution. The synthesis solution was heated to approximately 40° C. and stirred uniformly.

Under stirring, 819 g of a 44 wt. % formaldehyde solution was added dropwise to the synthesis solution over 20 minutes, during which the temperature of the synthesis solution elevated to approximately 90° C. The solution was heated and maintained at approximately 90° C. for 3 hours of reaction.

Subsequently, heating and stirring were stopped, and the mixture was allowed to stand for approximately 20 minutes. After the synthesis solution separated into two layers, the upper aqueous phase and trace emulsion were removed. The mixture was then reheated to approximately 90° C., and the solvent was recovered under reduced pressure below approximately 90 mmHg. After the temperature reached approximately 130° C. and all solvent was recovered, approximately 1,596 g of a carbon-oxygen heterocyclic compound was obtained. The reaction is as follows, and the resulting product, designated BZ-2, is an example of the compound of Formula 2, wherein Q in Formula 2 is —C(CH₃)₂—, and R₁₃, R₁₄, R₁₅, and R₁₆ are hydrogen atoms:

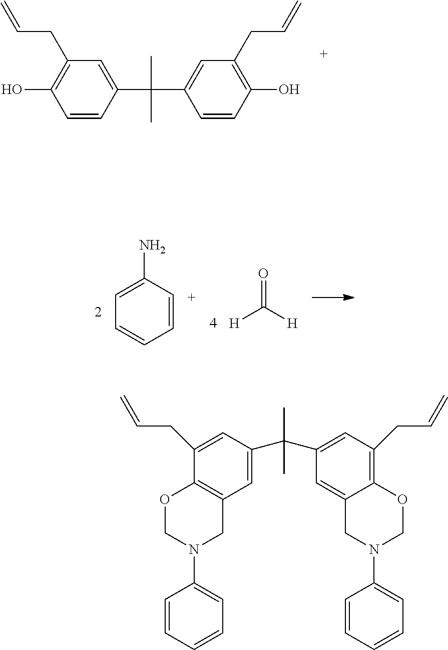

The composition of the synthesis solution maybe modified, 804 g of ortho-allylphenol, 594 g of diaminodiphenylmethane (MDA), and 600 g of toluene were added to a 3-liter four-neck separable reaction flask equipped with a heating device, thermometer, stirrer, cooling tube, dropping device, and vacuum recovery device, forming a synthesis solution. The synthesis solution was heated to approximately 40° C. and stirred uniformly.

Under stirring, 819 g of a 44 wt. % formaldehyde solution was added dropwise to the synthesis solution over 20 minutes, during which the temperature of the synthesis solution rose to approximately 90° C. The solution was heated and maintained at approximately 90° C. for 3 hours of reaction.

Subsequently, heating and stirring were stopped, and the mixture was allowed to stand for approximately 20 minutes. After the synthesis solution separated into two layers, the upper aqueous phase and trace emulsion were removed. The mixture was then reheated to approximately 90° C., and the solvent was recovered under reduced pressure below approximately 90 mmHg. After the temperature reached approximately 130° C. and all solvent was recovered, approximately 1,528 g of another carbon-oxygen heterocyclic compound, designated BZ-1, was obtained. The reaction is as follows, representing an example of the compound of Formula 3:

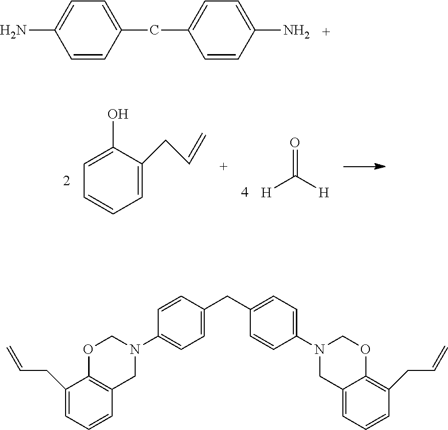

In this embodiment of BZ-1, Q is —CH₂—, R¹³ and R¹⁵ are allyl groups, and R¹⁴ and R¹⁶ are hydrogen atoms. However, R¹³, R¹⁴, R¹⁵, and R¹⁶ in Formula 3 are not limited to the substituents described above, provided that at least one of R¹³, R¹⁴, R¹⁵, and R¹⁶ is a functional group reactive with the double bond of a polyphenylene ether, such as vinyl, ethyl, or other applicable functional groups.

The preparation methods for the benzoxazine resins disclosed in the present invention are provided as examples only and are not intended to limit the invention.

To illustrate the technical objectives of the present invention, the following examples use substrates made from PPO-1A according to the present invention, compared with other comparative examples.

### Synthesis Example 1

The phosphorus-containing PPO prepared in this example is referred to as PPO-2A. In a 1-liter four-neck reaction kettle, 150 mL of toluene was added, followed by 0.25 g of copper chloride and 5.3 g of pyridine to prepare a metal composite catalyst.

59.8 g of 2,6-dimethylphenol and 10.8 g of 2,2′-diallyl bisphenol were formulated into a 50 wt. % methanol solution.

Oxygen was introduced, and the methanol solution was added dropwise to the reactor over 20 minutes. The temperature was then controlled between 30° C. and 35° C., and the reaction proceeded for 120 minutes. Upon completion, 1.05 g of 36.5 wt. % hydrochloric acid was added, stirred for 30 minutes, and 500 mL of methanol was added to precipitate the reaction product.

The precipitate was washed with methanol, and the filter cake was vacuum-dried at 110° C. for 4 hours, yielding 61 g of a PPO powder with a structure as shown in Formula 2a, with a number average molecular weight (Mn) of 2,074 and a weight average molecular weight (Mw) of 5,740.

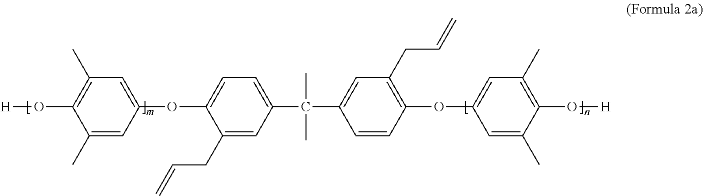 [SMILES: C=CCc1cc(C(C)(C)c2ccc(Oc3cc(C)c(O)c(C)c3)c(CC=C)c2)ccc1Oc1cc(C)c(O)c(C)c1]

The value of m+n in the formula of PPO-2a approximates 12.

Further, 30.0 g of 9,10-dihydro-9-oxa-10-phosphaphenanthrene-10-oxide (DOPO) was added to the reaction kettle, and the temperature was controlled at 140° C. until DOPO was fully melted. Then, 10.0 g of the PPO powder of Formula 2a was added with continuous stirring, and the temperature was raised to 170° C. for 20 hours. Upon completion, 100 mL of ethanol was added, the temperature was controlled at 78° C. until the reactants were fully dissolved, followed by the addition of 400 mL of water, with the temperature controlled at 85° C., and stirring and washing for 1 hour. The washing process was repeated four times, followed by solvent removal and drying, yielding 11.8 g of a phosphorus-containing PPO powder with a structure as shown in Formula 2A, with m+n approximating 12, a number average molecular weight (Mn) of approximately 2,532, and a weight average molecular weight (Mw) of 6,213.

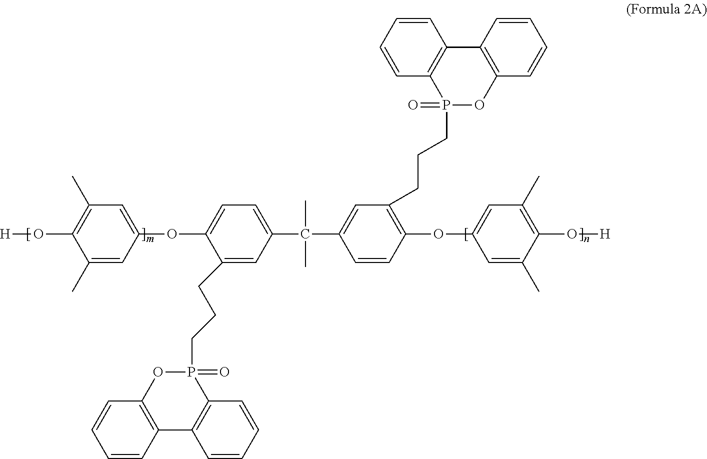 [SMILES: Cc1cc(Oc2ccc(C(C)(C)c3ccc(Oc4cc(C)c(O)c(C)c4)c(CCCP4(=O)Oc5ccccc5-c5ccccc54)c3)cc2CCCP2(=O)Oc3ccccc3-c3ccccc32)cc(C)c1O]

### Synthesis Example 2

The phosphorus-containing PPO prepared in this example is referred to as PPO-2B. In a 1-liter four-neck reaction kettle, 150 mL of toluene was added, followed by 0.25 g of copper chloride and 5.3 g of pyridine to prepare a metal composite catalyst.

54.9 g of 2,6-dimethylphenol and 15.4 g of 2,2′-diallyl bisphenol were formulated into a 50 wt. % methanol solution.

Oxygen was introduced, the temperature was controlled between 30° C. and 35° C., and the reaction proceeded for 120 minutes. Upon completion, 1.05 g of 36.5 wt. % hydrochloric acid was added, stirred for 30 minutes, and 500 mL of methanol was added to precipitate the reaction product.

The precipitate was washed with methanol, and the filter cake was vacuum-dried at 110° C. for 4 hours, yielding 58 g of a PPO powder with a structure as shown in Formula 2b, with a number average molecular weight (Mn) of 1,220 and a weight average molecular weight (Mw) of 3,420.

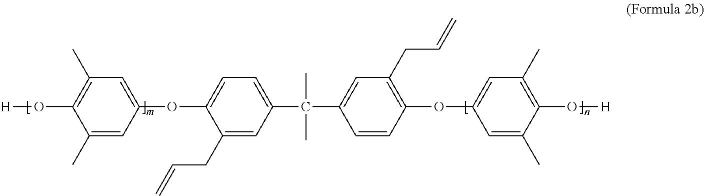 [SMILES: C=CCc1cc(C(C)(C)c2ccc(Oc3cc(C)c(O)c(C)c3)c(CC=C)c2)ccc1Oc1cc(C)c(O)c(C)c1]

The value of m+n in the formula of PPO-2b approximates 7.

Further, 30.0 g of 9,10-dihydro-9-oxa-10-phosphaphenanthrene-10-oxide (DOPO) was added to the reaction kettle, and the temperature was controlled at 140° C. until DOPO was fully melted. Then, 10.0 g of the PPO powder of Formula 2b was added with continuous stirring, and the temperature was raised to 170° C. for 20 hours. Upon completion, 100 mL of ethanol was added, the temperature was controlled at 78° C. until the reactants were fully dissolved, followed by the addition of 400 ml of water, with the temperature controlled at 85° C., and stirring and washing for 1 hour. The washing process was repeated four times, followed by solvent removal and drying, yielding 13.5 g of a phosphorus-containing PPO powder with a structure as shown in Formula 2B, with m+n approximating 7, a number average molecular weight (Mn) of approximately 1,708, and a weight average molecular weight (Mw) of 3,872.

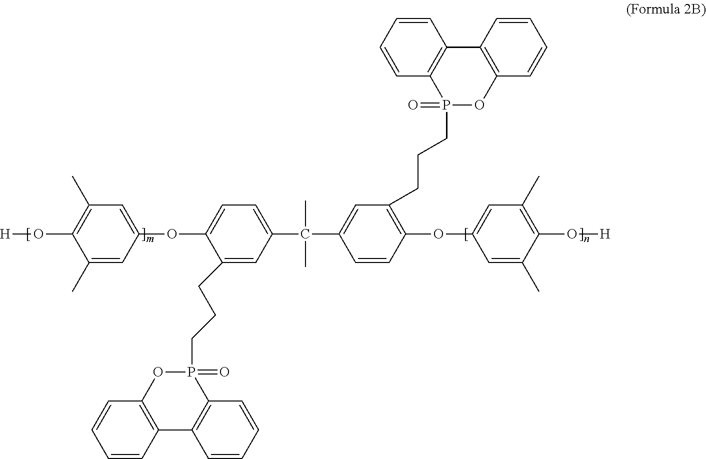 [SMILES: Cc1cc(Oc2ccc(C(C)(C)c3ccc(Oc4cc(C)c(O)c(C)c4)c(CCCP4(=O)Oc5ccccc5-c5ccccc54)c3)cc2CCCP2(=O)Oc3ccccc3-c3ccccc32)cc(C)c1O]

### Synthesis Example 3

The phosphorus-containing PPO prepared in this example is referred to as PPO-2C. In a 1-liter four-neck reaction kettle, 150 mL of toluene was added, followed by 0.25 g of copper chloride and 5.3 g of pyridine to prepare a metal composite catalyst.

51.2 g of 2,6-dimethylphenol and 21.5 g of 2,2′-diallyl bisphenol were formulated into a 50 wt. % methanol solution.

Oxygen was introduced, the temperature was controlled between 30° C. and 35° C., and the reaction proceeded for 120 minutes. Upon completion, 1.05 g of 36.5 wt. % hydrochloric acid was added, stirred for 30 minutes, and 500 mL of methanol was added to precipitate the reaction product.

The precipitate was washed with methanol, and the filter cake was vacuum-dried at 110° C. for 4 hours, yielding 57 g of a PPO powder with a structure as shown in Formula 2c, with a number average molecular weight (Mn) of 1,063 and a weight average molecular weight (Mw) of 2,523.

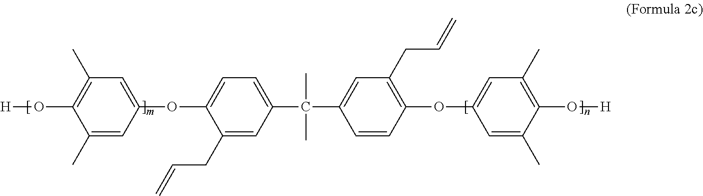 [SMILES: C=CCc1cc(C(C)(C)c2ccc(Oc3cc(C)c(O)c(C)c3)c(CC=C)c2)ccc1Oc1cc(C)c(O)c(C)c1]

The value of m+n in the formula of PPO-2c approximates 4.

Further, 30.0 g of 9,10-dihydro-9-oxa-10-phosphaphenanthrene-10-oxide (DOPO) was added to the reaction kettle, and the temperature was controlled at 140° C. until DOPO was fully melted. Then, 10.0 g of the PPO powder of Formula 2c was added with continuous stirring, and the temperature was raised to 170° C. for 20 hours. Upon completion, 100 mL of ethanol was added, the temperature was controlled at 78° C. until the reactants were fully dissolved, followed by the addition of 400 mL of water, with the temperature controlled at 85° C., and stirring and washing for 1 hour. The washing process was repeated four times, followed by solvent removal and drying, yielding 14.0 g of a phosphorus-containing PPO powder with a structure as shown in Formula 2C, with m+n approximating 4, a number average molecular weight (Mn) of approximately 1,560, and a weight average molecular weight (Mw) of 3,011.

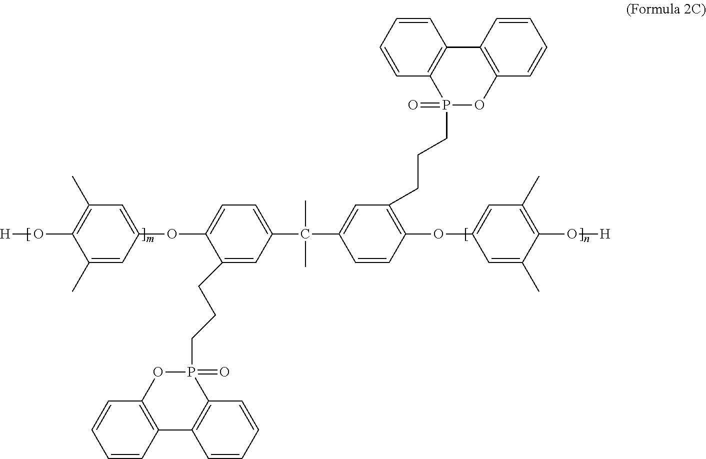 [SMILES: Cc1cc(Oc2ccc(C(C)(C)c3ccc(Oc4cc(C)c(O)c(C)c4)c(CCCP4(=O)Oc5ccccc5-c5ccccc54)c3)cc2CCCP2(=O)Oc3ccccc3-c3ccccc32)cc(C)c1O]

### Synthesis Example 4

The phosphorus-containing PPO prepared in this example is referred to as PPO-2D. In a 1-liter four-neck reaction kettle, 150 mL of toluene was added, followed by 0.25 g of copper chloride and 5.3 g of pyridine to prepare a metal composite catalyst.

59.8 g of 2,6-dimethylphenol and 14.5 g of ortho-diallyl cyclopentadienyl phenol resin were formulated into a 50 wt. % methanol solution.

Oxygen was introduced, the temperature was controlled between 30° C. and 35° C., and the reaction proceeded for 120 minutes. Upon completion, 1.05 g of 36.5 wt. % hydrochloric acid was added, stirred for 30 minutes, and 500 mL of methanol was added to precipitate the reaction product.

The precipitate was washed with methanol, and the filter cake was vacuum-dried at 110° C. for 4 hours, yielding 63 g of a PPO powder with a structure as shown in Formula 2d, with a number average molecular weight (Mn) of 1,530 and a weight average molecular weight (Mw) of 5,614.

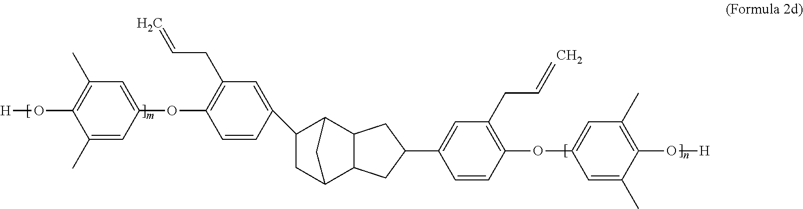

The value of m+n in the formula of PPO-2d approximates 12.

Further, 30.0 g of 9,10-dihydro-9-oxa-10-phosphaphenanthrene-10-oxide (DOPO) was added to the reaction kettle, and the temperature was controlled at 140° C. until DOPO was fully melted. Then, 10.0 g of the PPO powder of Formula 2d was added with continuous stirring, and the temperature was raised to 170° C. for 20 hours. Upon completion, 100 mL of ethanol was added, the temperature was controlled at 78° C. until the reactants were fully dissolved, followed by the addition of 400 mL of water, with the temperature controlled at 85° C., and stirring and washing for 1 hour. The washing process was repeated four times, followed by solvent removal and drying, yielding 12.5 g of a phosphorus-containing PPO powder with a structure as shown in Formula 2D, with m+n approximating 12, a number average molecular weight (Mn) of approximately 2,001, and a weight average molecular weight (Mw) of 6,046.

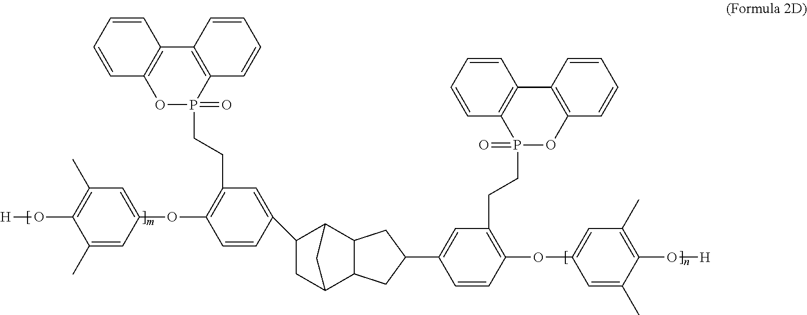 [SMILES: Cc1cc(Oc2ccc(C3CC4C5CC(c6ccc(Oc7cc(C)c(O)c(C)c7)c(CCP7(=O)Oc8ccccc8-c8ccccc87)c6)C(C5)C4C3)cc2CCP2(=O)Oc3ccccc3-c3ccccc32)cc(C)c1O]

### Synthesis Example 5

The phosphorus-containing PPO prepared in this example is referred to as PPO-2E. In a 1-liter four-neck reaction kettle, 150 mL of toluene was added, followed by 0.25 g of copper chloride and 5.3 g of pyridine to prepare a metal composite catalyst.

59.8 g of 2,6-dimethylphenol and 14.6 g of 2,2′-diallyl hexafluorobisphenol (diallyl bisphenol AF) were formulated into a 50 wt. % methanol solution.

Oxygen was introduced, the temperature was controlled between 30° C. and 35° C., and the reaction proceeded for 120 minutes. Upon completion, 1.05 g of 36.5 wt. % hydrochloric acid was added, stirred for 30 minutes, and 500 mL of methanol was added to precipitate the reaction product.

The precipitate was washed with methanol, and the filter cake was vacuum-dried at 110° C. for 4 hours, yielding 55 g of a PPO powder with a structure as shown in Formula 2e, with a number average molecular weight (Mn) of 1,296 and a weight average molecular weight (Mw) of 4,742.

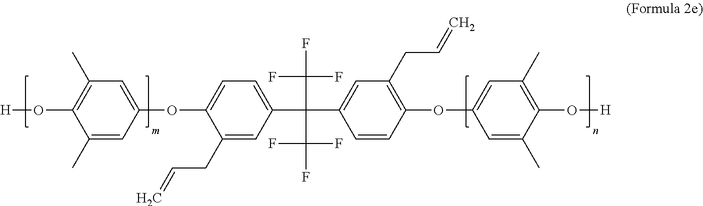

The value of m+n in the formula of PPO-2e approximates 12.

Further, 30.0 g of 9,10-dihydro-9-oxa-10-phosphaphenanthrene-10-oxide (DOPO) was added to the reaction kettle, and the temperature was controlled at 140° C. until DOPO was fully melted. Then, 10.0 g of the PPO powder of Formula 2e was added with continuous stirring, and the temperature was raised to 170° C. for 20 hours. Upon completion, 100 mL of ethanol was added, the temperature was controlled at 78° C. until the reactants were fully dissolved, followed by the addition of 400 mL of water, with the temperature controlled at 85° C., and stirring and washing for 1 hour. The washing process was repeated four times, followed by solvent removal and drying, yielding 11.9 g of a phosphorus-containing PPO powder with a structure as shown in Formula 2E, with m+n approximating 12, a number average molecular weight (Mn) of approximately 1,790, and a weight average molecular weight (Mw) of 5,132.

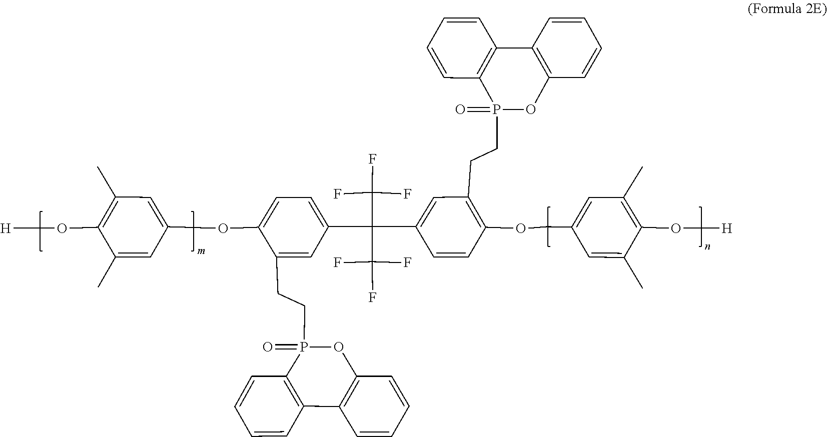

### Synthesis Example 6

The phosphorus-containing PPO prepared in this example is referred to as PPO-2F. In a 1-liter four-neck reaction kettle, 200 mL of cyclohexanone and 61.0 g of the phosphorus-containing PPO powder prepared in Synthesis Example 1 were added. The mixture was stirred and heated to 40° C. to dissolve the phosphorus-containing PPO powder, followed by the addition of 15.9 g of allyl chloride. The temperature was controlled at 40° C., and 5.6 g of a 50 wt. % NaOH aqueous solution was slowly added dropwise over 30 minutes. The temperature was then raised to 70° C., and the reaction proceeded for 200 minutes. The temperature was increased to 100° C. under reduced pressure to remove water and excess allyl chloride.

After washing with water, the temperature was raised to 150° C. under reduced pressure to remove cyclohexanone, yielding 63.2 g of a multifunctional phosphorus-containing PPO with a structure as shown in Formula 2F, with a number average molecular weight (Mn) of 2,670 and a weight average molecular weight (Mw) of 6,353.

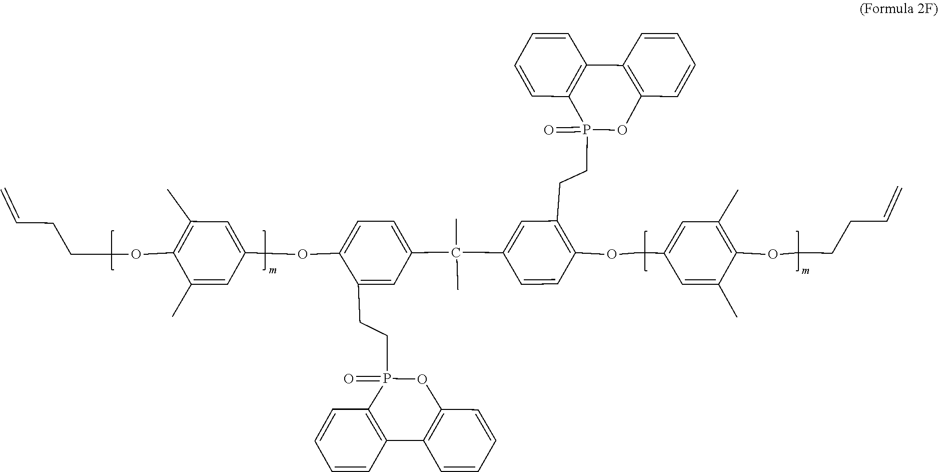

The value of m+n in the formula of PPO-2F approximates 12.

### Synthesis Example 7

The phosphorus-containing PPO prepared in this example is referred to as PPO-2G. In a 1-liter four-neck reaction kettle, 200 mL of cyclohexanone and 63.0 g of the phosphorus-containing PPO powder prepared in Synthesis Example 4 were added. The mixture was stirred and heated to 40° C. to dissolve the phosphorus-containing PPO powder, followed by the addition of 15.9 g of allyl chloride. The temperature was controlled at 40° C., and 5.6 g of a 50 wt. % NaOH aqueous solution was slowly added dropwise over 30 minutes. The temperature was then raised to 70° C., and the reaction proceeded for 200 minutes. The temperature was controlled at 100° C. under reduced pressure to remove water and excess allyl chloride.

After washing with water, the temperature was raised to 150° C. under reduced pressure to remove cyclohexanone, yielding 63.9 g of a multifunctional phosphorus-containing PPO with a structure as shown in Formula 2G, with a number average molecular weight (Mn) of 2,094 and a weight average molecular weight (Mw) of 6,051.

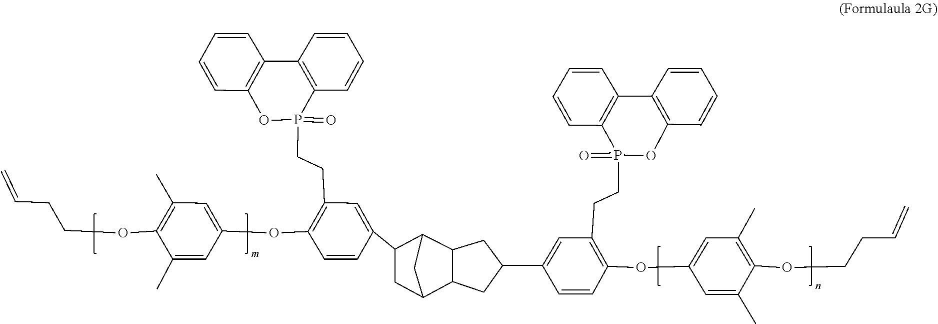

The value of m+n in the formula of PPO-2G approximates 12.

### Synthesis Example 8

The phosphorus-containing PPO prepared in this example is referred to as PPO-2H. In a 1-liter four-neck reaction kettle, 0.9 g of 4-dimethylaminopyridine (DMAP), 22.1 g of methacrylic anhydride, 150 mL of toluene, and 50.0 g of the phosphorus-containing PPO powder prepared according to Synthesis Example 4 were added, with the temperature controlled at 80° C. Upon completion of the reaction, the reaction solution was precipitated in a large amount of methanol, and the resulting precipitate was filtered under suction and washed with 300 mL of methanol with stirring for 30 minutes.

Subsequently, after suction filtration and drying under reduced pressure, 48.9 g of a multifunctional phosphorus-containing PPO with a structure as shown in Formula 2H was obtained, with a number average molecular weight (Mn) of 2,314 and a weight average molecular weight (Mw) of 6,249.

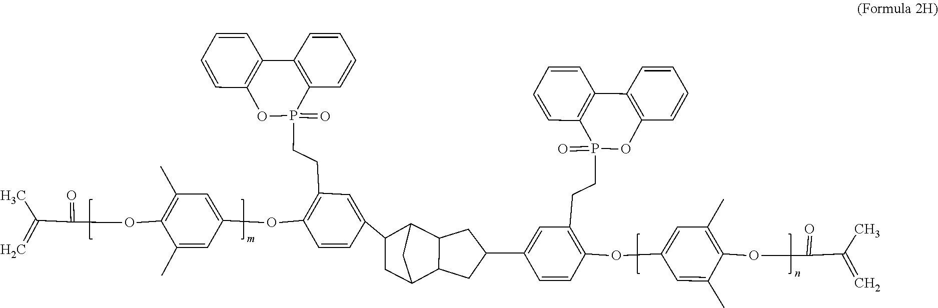

The value of m+n in the formula of PPO-2H approximates 12.

### Synthesis Example 9

The phosphorus-containing PPO prepared in this example is referred to as PPO-2I. In a 1-liter four-neck reaction kettle, 15.6 g of epichlorohydrin and 4.3 g of the phosphorus-containing PPO powder prepared according to Synthesis Example 3 were added, with the temperature controlled at 100° C. under a nitrogen atmosphere. Subsequently, a solution of 0.56 g of sodium ethoxide dissolved in 3.0 g of ethanol was prepared and slowly added dropwise to the reaction kettle. Upon completion of the reaction, the temperature was adjusted to room temperature, and toluene and deionized water were added for extraction. The resulting organic layer solution was concentrated, redissolved in toluene, and precipitated in methanol.

Subsequently, after suction filtration and drying under reduced pressure, 2.2 g of a multifunctional phosphorus-containing PPO with a structure as shown in Formula 2I was obtained, with a number average molecular weight (Mn) of 1,700 and a weight average molecular weight (Mw) of 3,361.

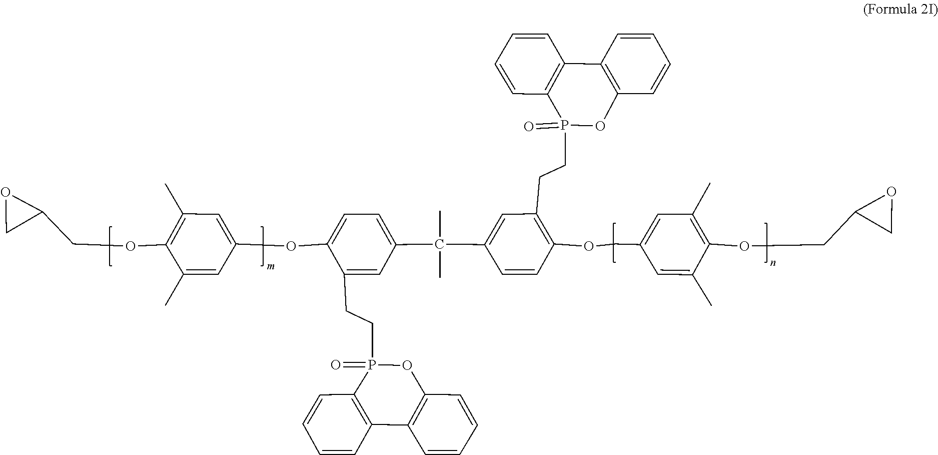

The value of m+n in the formula of PPO-2I approximates 4.

### Synthesis Example 10

The phosphorus-containing PPO prepared in this example is referred to as PPO-2J. In a 1-liter four-neck reaction kettle, 9.79 g of p-chloromethylstyrene, 8.86 g of potassium carbonate, 60 mL of dimethylacetamide, and 20.0 g of the phosphorus-containing PPO powder prepared according to Synthesis Example 3 were added. Under a nitrogen atmosphere, the temperature was raised to 100° C., and the reaction proceeded for 24 hours. After completion, the mixture was cooled to room temperature, and 500 mL of methanol was added to precipitate the reaction product.

The precipitate was washed with methanol, and the filter cake was vacuum-dried at 60° C. for 4 hours, yielding 21.6 g of a multifunctional phosphorus-containing PPO with a structure as shown in Formula 2J, with a number average molecular weight (Mn) of 1,917 and a weight average molecular weight (Mw) of 3,478.

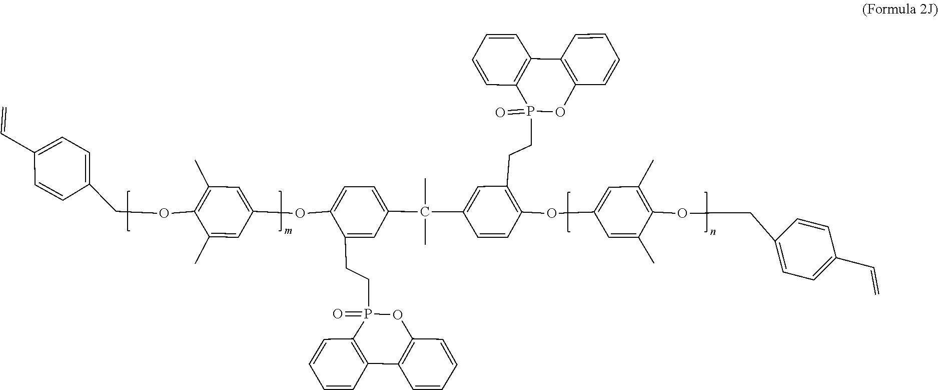

The value of m+n in the formula of PPO-2J approximates 4.

### Synthesis Example 11

The phosphorus-containing PPO prepared in this example is referred to as PPO-2K. In a 1-liter four-neck reaction kettle, 1.1 g of 4-dimethylaminopyridine (DMAP), 25.1 g of methacrylic anhydride, 150 mL of toluene, and 50.0 g of the phosphorus-containing PPO powder prepared according to Synthesis Example 2 were added, with the temperature controlled at 80° C. Upon completion of the reaction, the reaction solution was precipitated in a large amount of methanol, and the resulting precipitate was filtered under suction and washed with 300 mL of methanol with stirring for 30 minutes.

Subsequently, after suction filtration and drying under reduced pressure, 49.7 g of a multifunctional phosphorus-containing PPO with a structure as shown in Formula 2K was obtained, with a number average molecular weight (Mn) of 2,014 and a weight average molecular weight (Mw) of 4,241.

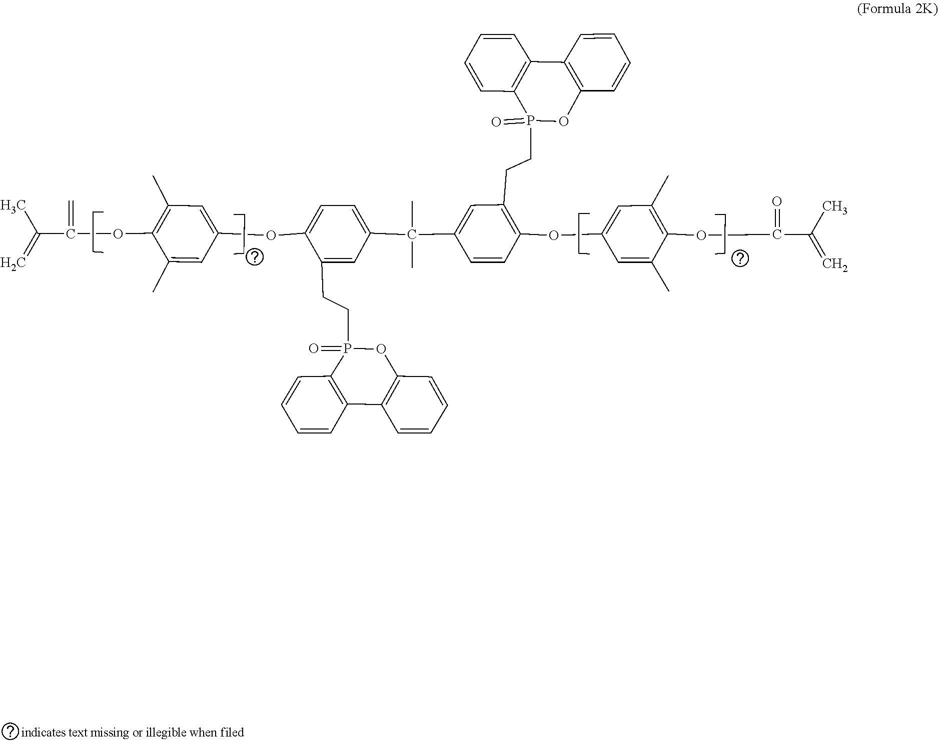

The value of m+n in the formula of PPO-2K approximates 7.

In one specific example of a resin, the resin may comprise a phosphorus-containing polyphenylene ether resin, a benzoxazine resin with crosslinkable functional groups, and a bismaleimide (BMI) resin with a structure as shown in Formula 4:

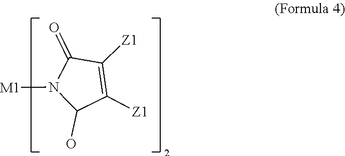

M1 may be a substituted or unsubstituted methylene group, 4,4′-diphenylmethane, m-phenylene, bisphenol A diphenyl ether, 3,3′-dimethyl-5,5′-diethyl-4,4′-diphenylmethane, 4-methyl-1,3-phenylene, or (2,2,4-trimethyl) hexane, and Z1 is independently hydrogen, halogen, or a C1 to C5 alkyl.

The above embodiments utilize the phosphorus-containing polyphenylene ether resin disclosed in the present invention in combination with the benzoxazine resin of Formula 2 or Formula 3, but the present invention is not limited thereto. Any benzoxazine resin with crosslinkable functional groups may be used in combination with the phosphorus-containing polyphenylene ether resin disclosed herein for various applications.

Furthermore, the resin may additionally include at least one additive selected from elastomers, catalysts, flame retardants, fillers, dispersants, or toughening agents. Among these, suitable flame retardants for the present invention include phosphorus-containing flame retardants, bromine-containing flame retardants, or combinations thereof; fillers may include silica, alumina, magnesium oxide, magnesium hydroxide, calcium carbonate, talc, clay, aluminum nitride, boron nitride, aluminum hydroxide, aluminum silicon carbide, silicon carbide, sodium carbonate, titanium dioxide, zinc oxide, zirconium oxide, quartz, diamond, diamond-like carbon, graphite, calcined kaolin, kaolin, mica, hydrotalcite, hollow silica, polytetrafluoroethylene (PTFE) powder, glass beads, ceramic whiskers, carbon nanotubes, or nanoscale inorganic powders; elastomers may include polybutadiene, polyisoprene, or styrene-containing polymers; catalysts may include dicumyl peroxide, α,α′-bis(t-butylperoxy)diisopropylbenzene, or benzoyl peroxide (BPO).

What is claimed is:

1. A resin having a structure represented by the following Formula A: 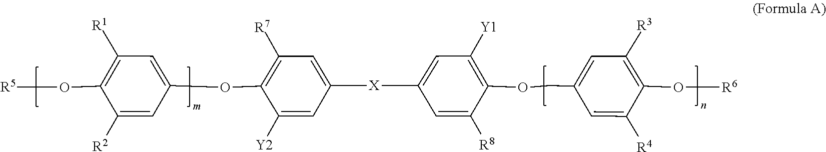
wherein each of the substituents R¹ to R⁴ are the same or different, and are independently selected from hydrogen, a substituted or unsubstituted aromatic ring, a substituted or unsubstituted C1 to C5 alkyl, and a substituted or unsubstituted C2 to C5 alkenyl;
m and n are each independently an integer ranging from 0 to 100, with the proviso that m and n are not simultaneously 0;
wherein each of the substituents R⁵ and R⁶ are the same or different, and are independently selected from hydrogen, a group comprising an alkenyl moiety, 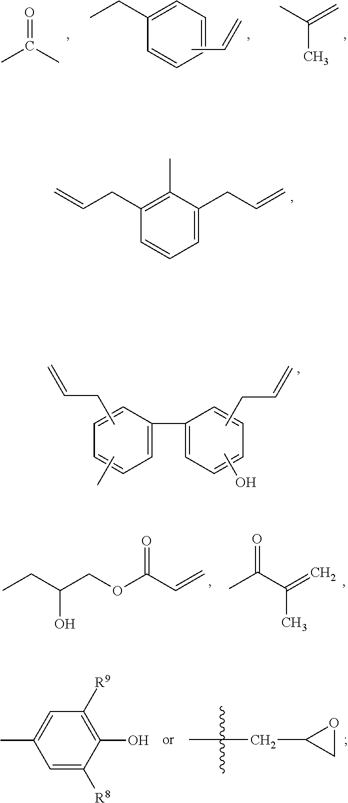
wherein X is a single bond, —CH₂—, 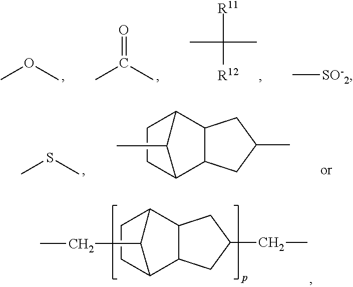
wherein p is a positive integer;
wherein each of the substituents R⁷ to R¹² are the same or different, and are independently selected from hydrogen, a C1 to C12 alkyl, or CF₃;
wherein each of the substituents Y1 and Y2 are the same or different, and are independently selected from a functional group comprising 9,10-dihydro-9-oxa-10-phosphaphenanthrene-10-oxide (DOPO).

2. The resin according to claim 1, wherein the resin has a number average molecular weight (Mn) and a weight average molecular weight (Mw), Mn and Mw satisfy at least one of the following:
Mn ranges from 1,000 to 15,000;
Mw ranges from 1,000 to 25,000; and
the ratio Mw/Mn ranges from 1 to 25.

3. The resin according to claim 1, wherein repeating units in the Formula A contains no phosphorus-containing functional groups.

4. The resin according to claim 1, wherein capping structure in the Formula A contains no phosphorus-containing functional groups.

5. The resin according to claim 1, wherein linking group X in the Formula A contains no phosphorus-containing functional groups.

6. A resin having a structure represented by the following Formula B: 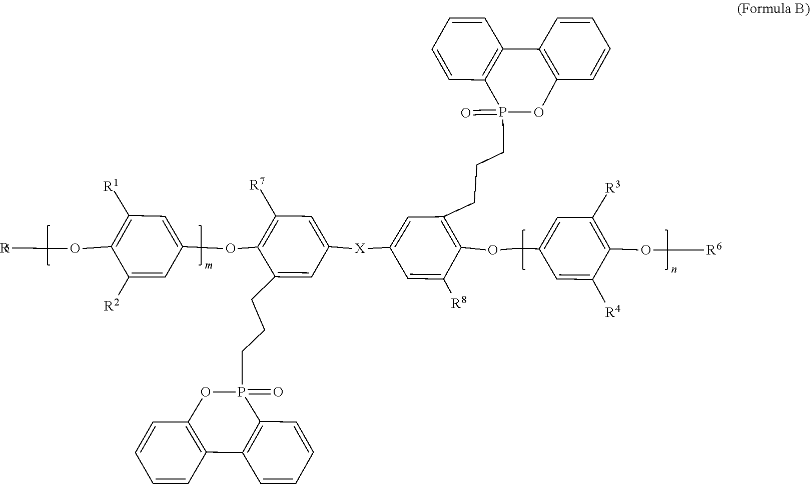
wherein each of the substituents R¹ to R⁴ are the same or different, and are independently selected from hydrogen, a substituted or unsubstituted aromatic ring, a substituted or unsubstituted C1 to C5 alkyl, and a substituted or unsubstituted C2 to C5 alkenyl;
m and n are each independently an integer ranging from 0 to 100, with the proviso that m and n are not simultaneously 0;
wherein each of the substituents R⁵ and R⁶ are the same or different, and are independently selected from hydrogen, a group comprising an alkenyl moiety, 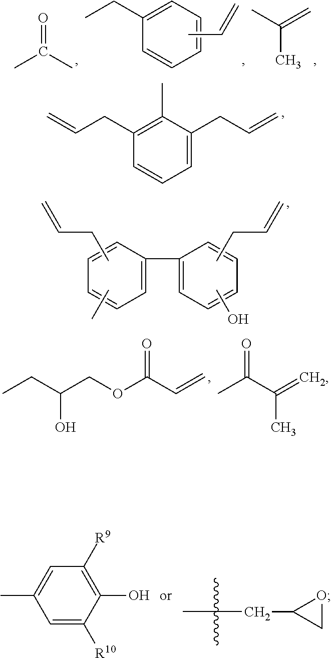
wherein X is a single bond, —CH₂—, 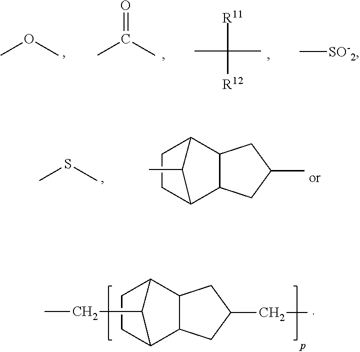
wherein p is a positive integer;
wherein each of the substituents R⁷ to R¹² are the same or different, and are independently selected from hydrogen, a C1 to C12 alkyl, or CF₃;

7. The resin according to claim 3, wherein the resin has a number average molecular weight (Mn) and a weight average molecular weight (Mw), Mn and Mw satisfy at least one of the following:
Mn ranges from 1,000 to 15,000;
Mw ranges from 1,000 to 25,000; and
the ratio Mw/Mn ranges from 1 to 25.

8. The resin according to claim 6, wherein repeating units in the Formula A contains no phosphorus-containing functional groups.

9. The resin according to claim 6, wherein capping structure in the Formula A contains no phosphorus-containing functional groups.

10. The resin according to claim 6, wherein linking group X in the Formula A contains no phosphorus-containing functional groups.

11. A low molecular weight phosphorus-containing polyphenylene ether resin comprising 2,6-dimethylphenylene ether and one or more phosphorus-containing functional groups comprising 9,10-dihydro-9-oxa-10-phosphaphenanthrene-10-oxide (DOPO) attached to the 2,6-dimethylphenylene ether, wherein the phosphorus-containing functional groups are attached onto symmetrical phenyl rings on both sides of a central core unit of the 2,6-dimethylphenylene ether via an alkenyl during synthesis, and wherein the polyphenylene ether resin has a number average molecular weight (Mn) and a weight average molecular weight (Mw) satisfying at least one of the following:
Mn ranges from 1,000 to 15,000;
Mw ranges from 1,000 to 25,000; and
the ratio Mw/Mn ranges from 1 to 25.

12. The low molecular weight phosphorus-containing polyphenylene ether resin according to claim 11, wherein the alkenyl is an allyl group.

13. The low molecular weight phosphorus-containing polyphenylene ether resin according to claim 11, wherein the low molecular weight phosphorus-containing polyphenylene ether resin is characterized as a C-B-A-B′-C′ structure, wherein A is a central core unit including a linking group connected with two phenyl rings on both sides, B and B′ are repeating units symmetrically attached to the central core unit on both sides, and C and C′ are termini modified with specific capping groups, symmetrically attached to the repeating units, forming a linear structure.

14. The low molecular weight phosphorus-containing polyphenylene ether resin according to claim 11, wherein the repeating units B, B′ contain no phosphorus-containing functional groups.

15. The low molecular weight phosphorus-containing polyphenylene ether resin according to claim 11, wherein the termini C, C′ contain no phosphorus-containing functional groups.

16. The low molecular weight phosphorus-containing polyphenylene ether resin according to claim 11, wherein the linking group contains no phosphorus-containing functional groups.
